(19) United States
(12) Patent Application Publication
(10) Pub. No.: US 2026/0186336 A1
(43) Pub. Date: Jul. 2, 2026

(54) DISPLAY DEVICE

(71) Applicant: LG DISPLAY CO., LTD., Seoul (KR)

(72) Inventor: Woong Jin SEO, Paju-si (KR)

(73) Assignee: LG DISPLAY CO., LTD., Seoul (KR)

(21) Appl. No.: 19/432,648

(22) Filed: Dec. 24, 2025

(30) Foreign Application Priority Data
Dec. 31, 2024 (KR) 10-2024-0202529

(51) Int. Cl. G02F 1/1333; G02F 1/1335

(52) U.S. Cl. CPC G02F 1/13338; G02F 1/133526; G02F 1/133553

(57) ABSTRACT

A display device can include a display panel including a light transmission area, a concave lens located below the display panel and overlapping with the light transmission area, a light guide module located below the concave lens, a convex lens located at a side of the light guide module, and an optical sensor module located adjacent to the convex lens. Additionally, the concave lens can further include a concave-shaped Fresnel lens or a polarized concave lens and the convex lens can include a convex-shaped Fresnel lens or a polarized convex lens.

### CROSS-REFERENCE TO RELATED APPLICATION

This application claims priority to and the benefit of Korean Patent Application No. 10-2024-0202529, filed Dec. 31, 2024, the disclosure of which is incorporated by reference in its entirety.

### BACKGROUND

### Field

The present disclosure relates to a display device including a light guide module.

### Discussion of Related Art

Generally, liquid crystal display devices exhibit superior display resolution compared to other flat panel display devices, and when implementing moving images, they demonstrate fast response speeds comparable to cathode ray tubes in terms of quality, thereby improving image quality.

The driving principle of liquid crystal display devices utilizes the optical anisotropy and polarization properties of liquid crystals. Since liquid crystals have an elongated, slender structure, the direction of their molecular arrangement can be controlled by artificially applying an electric field to the liquid crystal molecules having directionality and polarization in the molecular arrangement.

Therefore, in the liquid crystal display devices, by arbitrarily controlling the alignment direction, light can be transmitted or blocked according to the arrangement direction of liquid crystal molecules due to the optical anisotropy of the liquid crystals, thus enabling the display of colors and images.

Additionally, active matrix type liquid crystal display devices add active elements having nonlinear characteristics to each pixel arranged in a matrix form, and control the operation of each pixel using the switching characteristics of the active elements, thereby implementing memory functions through the electro-optical effects of liquid crystals.

### SUMMARY OF THE DISCLOSURE

The embodiments of the present disclosure address these limitations associated with the related art, and provide a display device that includes an optical structure combining concave and convex lenses to increase the field of view (FOV) while maintaining the aperture size of the light transmission area of the display device.

The technical problems addressed by the embodiments of the present disclosure are not limited to the above-mentioned problems, and other problems not mentioned will be clearly understood by those skilled in the art from the following description.

A display device according to one embodiment of the present disclosure can include a display panel including a plurality of pixel array areas and a light transmission area, a concave lens positioned below the display panel and overlapping with the light transmission area, a light guide module positioned below the concave lens, a convex lens disposed on one side of the light guide module, and an optical sensor module disposed to face the convex lens.

A display device according to another embodiment of the present disclosure can include a display panel including a plurality of pixel array areas and a light transmission area, a light guide module disposed below the display panel, and an optical sensor module disposed to face one side of the light guide module, in which the light guide module can include a concave lens portion overlapping with the light transmission area and a convex lens portion overlapping and facing the optical sensor module.

Specific details according to various examples of the present disclosure other than the above-mentioned technical solutions are included in the following description and drawings.

According to aspects of the present disclosure, by arranging concave and convex lenses on the upper side and one side of the light guide module facing the optical sensor module to perform primary and secondary refraction on external light, the field of view (FOV) can be increased by utilizing an optical sensor module even with the same aperture size of the light transmission area as conventional devices.

According to aspects of the present disclosure, by applying polarization-dependent polarized concave and convex lenses whose refraction form varies depending on the presence or absence of polarization, light received by the optical sensor module is refracted, while light emitted from the second light source toward the outside is not refracted, thereby minimizing or preventing display image quality degradation.

The effects of the present disclosure are not limited to the above-mentioned effects, and other effects not mentioned will be clearly understood by those having ordinary skill in the technical field to which the technical idea of the present disclosure belongs from the following description.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a diagram showing a screen of a display device according to a first embodiment of the present disclosure;

FIG. 2 is a diagram showing a rear surface of the display device according to the first embodiment of the present disclosure;

FIG. 3 is an exploded perspective view of the display device according to the first embodiment of the present disclosure;

FIG. 4 is a cross-sectional view of the display device according to the first embodiment of the present disclosure;

FIG. 5 is an enlarged cross-sectional view of the display panel of the display device according to the first embodiment of the present disclosure;

FIG. 6 is a perspective view showing an enlarged concave lens in the display device according to the first embodiment of the present disclosure;

FIG. 7 is a cross-sectional view taken along line I-I′ of FIG. 6;

FIG. 8 is a perspective view showing an enlarged convex lens in the display device according to the first embodiment of the present disclosure;

FIG. 9 is a cross-sectional view taken along line II-II′ of FIG. 8;

FIG. 10 is a cross-sectional view of a display device according to a second embodiment of the present disclosure;

FIG. 11 is an enlarged cross-sectional view showing a propagation path where light coming from the outside is primarily refracted in the display device according to the second embodiment of the present disclosure;

FIG. 12 is an enlarged cross-sectional view showing a propagation path of secondarily refracted light in the display device according to the second embodiment of the present disclosure;

FIG. 13 is a cross-sectional view of a display device according to a third embodiment of the present disclosure;

FIG. 14 is a cross-sectional view of a polarized concave lens in the display device according to the third embodiment of the present disclosure, showing a propagation path of unpolarized light passing through the polarized concave lens;

FIG. 15 is a cross-sectional view of a polarized convex lens in the display device according to the third embodiment of the present disclosure, showing a propagation path of unpolarized light passing through the polarized convex lens;

FIG. 16 is a cross-sectional view of a polarized concave lens in the display device according to the third embodiment of the present disclosure, showing a propagation path of polarized light passing through the polarized concave lens;

FIG. 17 is a cross-sectional view of a polarized convex lens in the display device according to the third embodiment of the present disclosure, showing a propagation path of polarized light passing through the polarized convex lens;

FIG. 18 is a cross-sectional view showing a propagation path of light emitted from a second light source in the display device according to the third embodiment of the present disclosure;

FIG. 19 is a cross-sectional view showing a propagation path where polarized light is received by an optical sensor module through a polarized concave lens in the display device according to the third embodiment of the present disclosure; and

FIG. 20 is a cross-sectional view of a display device according to a fourth embodiment of the present disclosure.

### DETAILED DESCRIPTION OF THE EMBODIMENTS

The advantages and features of the present disclosure, and methods of achieving them will be apparent from the embodiments described in detail below in conjunction with the accompanying drawings. However, the present disclosure is not limited to the following embodiments disclosed herein, but can be implemented in various different forms, rather, the present embodiments are provided to make the disclosure of the present specification complete and to enable those skilled in the art to fully comprehend the scope of the present disclosure.

The shapes, sizes, proportions, angles, numbers, and the like of elements shown in the drawings to illustrate embodiments of the present disclosure are merely illustrative and are not intended to be limiting. Identical reference numerals can designate identical components throughout the description. Further, in describing the present disclosure, detailed descriptions of related known technologies can be omitted so as not to obscure the essence of the present disclosure. The terms such as “including,” “having,” and “consisting of” as used herein are generally intended to allow other components to be added unless the terms are used with the term “only.” References to components of a singular noun include the plural of that noun, unless specifically stated otherwise. Furthermore, the term “can” fully encompasses all the meanings and coverages of the term “may” and vice versa.

In the interpretation of components, they are construed to include margins of error, even if not explicitly stated.

When describing a positional relationship, for example, “on top of,” “above,” “below,” “next to,” or “adjacent to” describes the positional relationship of two parts, one or more other parts can be located between the two parts, unless “immediately,” “directly,” or “near to” is used.

When describing a temporal relationship, “after,” “subsequently to,” “following,” or, “before” describes a temporal antecedent or consequent relationship, which may not be continuous unless “immediately,” or “directly” is used.

The term “exemplary” is used to mean an example, and is interchangeably used with the term “example”. Further, embodiments are example embodiments and aspects are example aspects. Any implementation described herein as an “example” is not necessarily to be construed as preferred or advantageous over other implementations.

The first, the second, and so on are used to describe various components, but these components are not limited by these terms. These terms are used only to distinguish one component from another. Therefore, a first component referred to below can be a second component within the technical spirit of the present disclosure.

Terms such as first, second, A, B, (a), or (b) can be used to describe elements of the embodiments of the present disclosure. Such terms are intended only to distinguish one component from another and are not intended to define the nature, sequence, order, or number of such components.

When a component is described as being “connected,” “coupled”, “accessed,” or “attached” to another component, it is to be understood that the component can be directly connected, coupled, accessed, or attached to the other component, but that there can also be other components interposed between the respective components which can be indirectly connected, coupled, accessed, or attached, unless specifically stated otherwise. In other words, no directed connection is required between connected components.

When a component is described as being “in contact” or “overlapping” with another component, it is to be understood that the component can be in direct contact or overlap with the other component, but other components can also be “interposed” between the these components, resulting in indirect contact or overlap, unless specifically stated otherwise.

It should be understood that the term “at least one” includes all possible combinations of one or more related components. For example, the meaning of “at least one of the first, second, and third components” can be understood to include not only the first, second, or third component, but also any combination of two or more of the first, second, and third components.

The terms such as “the first direction,” “the second direction,” “the third direction,” “the X-axis direction,” “the Y-axis direction,” and “the Z-axis direction” are not to be interpreted solely as a geometric relationship in which the relationship to one another is perpendicular, but can refer to a broader range of orientations in which the configurations of the present disclosure can function.

As used herein, a device can include a display device, such as a liquid crystal module (LCM) or an organic light-emitting display (OLED) module, which includes a display panel and a driver for driving the display panel. It can also include a set electronic apparatus or a set device, such as a laptop computer, a television set, a computer monitor, a vehicle or an automotive apparatus, or an equipment apparatus including another form of vehicle, and a mobile electronic apparatus, such as a smart phone or an electronic pad and the like, which is a complete product or finished product including LCMs, OLED modules, and the like.

Therefore, the device in the present disclosure can include a display device itself, such as an LCM module, an OLED module, and the like, and a set device which is an application product or an end-consumer device including the LCM, OLED module, and the like.

Furthermore, in some embodiments, an LCM module and an OLED module composed of a display panel and a driver can be expressed as a display device, and an electronic device as a finished product including the LCM, OLED module (or panel) can be distinguished and expressed as a set device.

For example, the display device can include a liquid crystal display (LCD) panel or an organic light-emitting diode (OLED) display panel, and a source printed circuit board (PCB) which is a control part for driving the display panel. The set device can further include a set PCB, which is a set control part electrically connected to the source PCB to drive the entire set device.

The display panels used in the embodiments of the present disclosure can be any type of display panels such as a liquid crystal display panel, an organic light-emitting diode (OLED) display panel, and an electroluminescent display panel, but the embodiments are not limited thereto. For example, the display panel can be a display panel capable of generating sound by being vibrated by a vibration device according to the embodiments of the present disclosure. The display panel applied to the display device according to the embodiments of the present disclosure is not limited to the form or size of the display panel.

Each of the features of various embodiments of the present disclosure can be coupled or combined with one another in whole or in part, and can be technologically interlocked and operated in various ways, and each of the embodiments can be carried out independently or in conjunction with one another.

Hereinafter, various embodiments of the present disclosure will be described in detail with reference to the accompanying drawings. All the components of each display device/apparatus according to all embodiments of the present disclosure are operatively coupled and configured. The scale of the components shown in the drawings has a different scale from the actual scale for convenience of explanation and is not limited to the scale shown in the drawings.

Various display devices such as liquid crystal display devices, organic electroluminescent display devices, electrophoretic display devices, mini LED (Light Emitting Diode) display devices, and micro LED display devices can be applied to the display device of the present disclosure, but for convenience of explanation, liquid crystal display devices will be described as examples below.

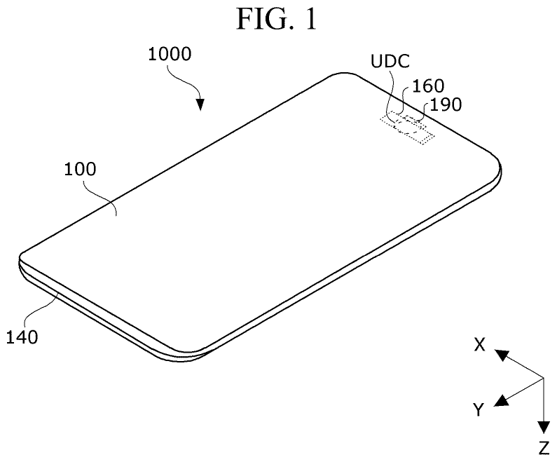

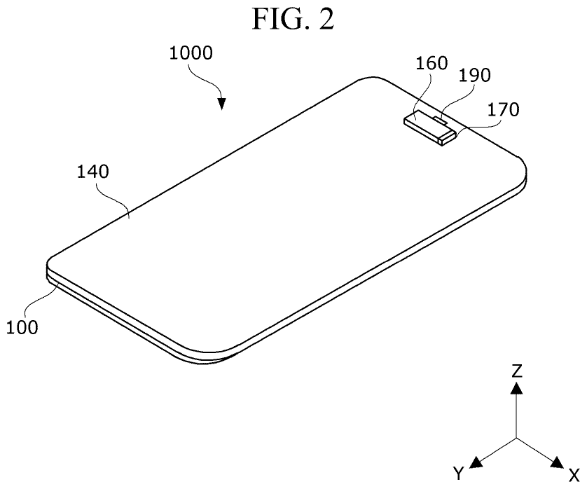

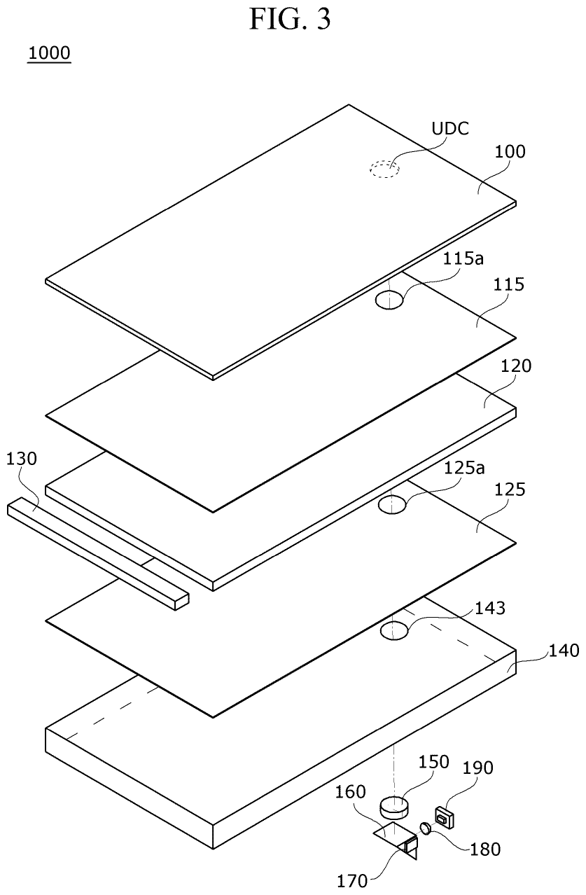

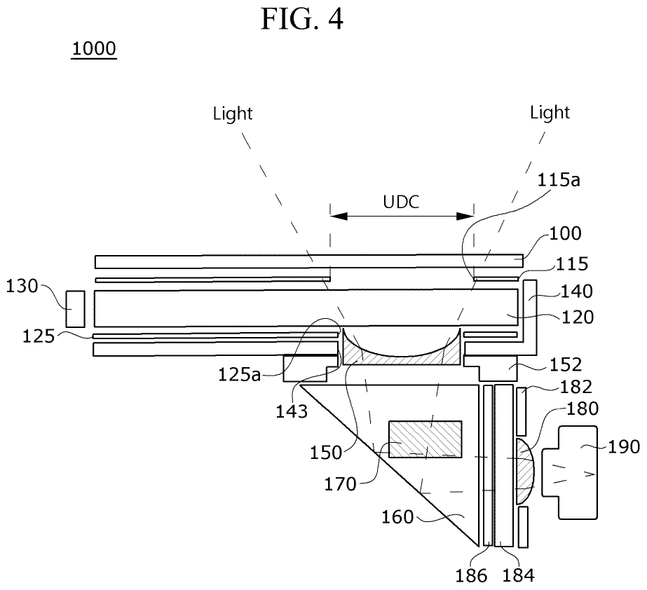

FIG. 1 is a diagram showing a screen of a display device according to a first embodiment of the present disclosure. FIG. 2 is a diagram showing a rear surface of the display device according to the first embodiment of the present disclosure. FIG. 3 is an exploded perspective view of the display device according to the first embodiment of the present disclosure. FIG. 4 is a cross-sectional view of the display device according to the first embodiment of the present disclosure.

Referring to FIGS. 1 to 4, a display device 1000 can include a display panel 100, a bottom cover 140 surrounding the display panel 100, a light guide module 160 disposed on a lower surface of the bottom cover 140, and an optical sensor module 190 disposed on a side surface of the light guide module 160 to avoid a light transmission area UDC so as not to overlap with the light transmission area UDC defined on an upper surface of the display panel 100.

Herein, the display panel 100 can include a liquid crystal display (LCD), an organic light-emitting diode display (OLED), and other display devices, but in the present disclosure, a liquid crystal display panel will be described as an example. However, the present disclosure is not limited thereto.

An optical sheet 115 can be disposed below the display panel 100, and a light guide plate 120 can be disposed below the optical sheet 115. A first opening 115a can be formed on an upper surface of the optical sheet 115 to overlap with the light transmission area UDC. The first opening 115a can be located towards one end of the optical sheet 115. However, the present disclosure is not limited thereto.

A first light source 130 can be disposed on one side of the light guide plate 120. For example, the first light source 130 can be located on a side of the light guide plate 120 away from the first opening 115a. The first light source 130 can be composed of LEDs. Here, the LED can be composed of white LEDs or can be composed of red LED/green LED/blue LED. The first light source 130 can also be composed of a cold cathode fluorescent lamp (e.g., CCFL) or an external electrode fluorescent lamp (e.g., EEFL). However, the present disclosure is not limited thereto.

In this case, light emitted from the first light source 130 travels straight upward through the light guide plate 120, passes through the optical sheet 115, and is directed toward the display panel 100.

A reflection sheet 125 can be disposed below the light guide plate 120. A second opening 125a can be formed on an upper surface of the reflection sheet 125 to overlap with the light transmission area UDC. A width of the second opening 125a can correspond to a width of the first opening 115a.

The reflection sheet 125, the light guide plate 120, the first light source 130, the optical sheet 115, and the display panel 100 can be disposed within the bottom cover 140 disposed below the reflection sheet 125. The bottom cover 140 surrounds the reflection sheet 125, the light guide plate 120, the first light source 130, the optical sheet 115, and the display panel 100 to constitute the display device 1000.

Here, a third opening 143 can be formed on a lower surface of the bottom cover 140 to overlap with the first opening 115a and the second opening 125a that overlap with the light transmission area UDC. A width of the third opening 143 can correspond to widths of the second opening 125a and the first opening 115a.

A light guide module 160 can be disposed below the bottom cover 140, and light guide module 160 may have a triangular prism shape, but it is not limited thereto. The light guide module 160 can be coupled and fixed to the bottom cover 140 by a guide module support 152 provided on a lower surface of the bottom cover 140. However, the present disclosure is not limited thereto.

A concave lens 150 can be disposed within the third opening 143 located on the lower surface of the bottom cover 140. The concave lens 150 can be disposed to overlap with the light transmission area UDC, the first and second openings 115a and 125a, and an upper surface of the light guide module 160. In this case, the concave lens 150 can be disposed within the third opening 143 provided on the lower surface of the bottom cover 140 to overlap with the light guide module 160, thereby serving to primarily refract the angle of the optical path of light coming from outside.

A convex lens 180 can be disposed between one side surface of the light guide module 160 and the optical sensor module 190. Optical filters 184 and 186 that selectively transmit light of a specific wavelength band can be disposed between the light guide module 160 and the convex lens 180. The optical filters 184 and 186 can overlap each other in a reflection direction of the transmitted light. Further, a thickness of an optical filter 184 can be greater than a thickness of the optical filter 186. The convex lens 180 can be coupled and fixed by a lens support 182.

The convex lens 180 can be coupled and fixed to the lens support 182 and can be positioned to overlap with the light guide module 160 and the optical sensor module 190. External light entering through the display panel 100 is primarily refracted through the concave lens 150, and the primarily refracted light passes through the light guide module 160, is secondarily refracted through the convex lens 180 before being received by the optical sensor module 190.

A second light source 170 can be disposed on the other side surface of the light guide module 160. The second light source 170 can be provided to prevent a dark state of the light guide module 160. The brightness state inside the light guide module 160 can be improved due to the operation of the second light source 170.

The second light source 170 can be composed of LEDs. Here, the LED can be composed of white LEDs or can be composed of red LED/green LED/blue LED. The first light source 130 can also be composed of a cold cathode fluorescent lamp (CCFL) or an external electrode fluorescent lamp (EEFL). The second light source 170 can be disposed on the other side surface of the light guide module 160 and is positioned so as not to overlap with the light transmission area UDC, the first to third openings 115a, 125a, and 143, and the concave lens 150. The second light source 170 is also positioned so as not to overlap with the convex lens 180 and the optical sensor module 190. However, the present disclosure is not limited thereto.

The optical sensor module 190 can include one or more optical sensors such as an imaging module (or camera) including an image sensor, an infrared sensor module, and an illuminance sensor module. The optical sensor module 190 can be disposed below the display panel 100 in a position that avoids the light transmission area UDC, that is, does not overlap with the light transmission area UDC. The optical sensor module 190 can overlap with the light guide module 160 but is not limited thereto.

The light guide module 160 is disposed between the light transmission area UDC of the display panel 100 and the optical sensor module 190 and can guide light from the second light source 170 to the light transmission area UDC. On the other hand, the light guide module 160 can refract external light entering through the light transmission area UDC of the display panel 100 through the convex lens 180 toward the optical sensor module 190. That is, external light guided by the light guide module 160 can propagate to the optical sensor module 190, which is positioned to avoid the light transmission area UDC. Accordingly, light that enters through the light transmission area UDC can be reflected to the convex lens 180 and the optical sensor module 190.

Therefore, since there are no pixels or wires connected to the pixels on the propagation path of external light heading to the optical sensor module 190, external light can reach the optical sensor module 190 without interference.

Additionally, light emitted from the second light source 170 can travel through the light guide module 160 toward its upper surface and be emitted toward the outside of the display panel 100. When a user views the screen of the display device 1000 from the outside, the user can see images reproduced on the display panel 100.

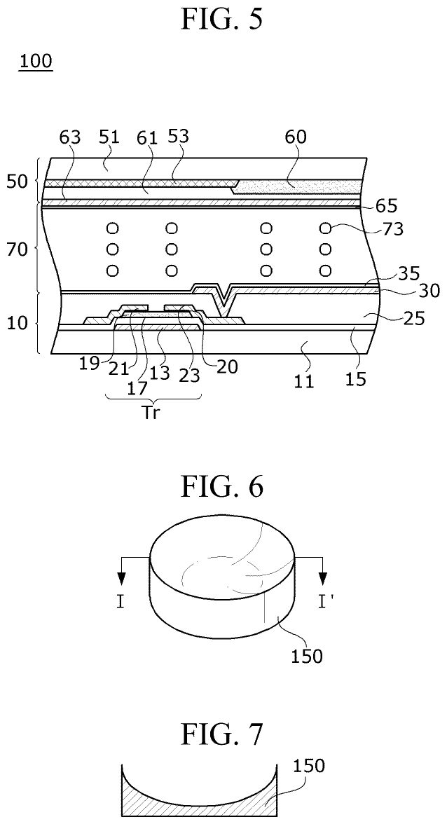

FIG. 5 is an enlarged cross-sectional view of the display panel of the display device according to the first embodiment of the present disclosure.

Referring to FIG. 5, the pixel array cross-sectional structure of the display panel 100 constituting the display device 1000 can include a lower display plate 10, an upper display plate 50 disposed vertically facing the lower display plate 10, and a liquid crystal cell 70 provided between the lower display plate 10 and the upper display plate 50.

In addition, the lower display plate 10 can include an array element having thin film transistors and a pixel electrode formed on the array element to transmit incident light and display images.

The array element can include a plurality of gate lines formed in a first direction, a plurality of data lines formed in a direction perpendicular to the gate lines, pixel areas defined by the gate lines and data lines, and thin film transistors formed at intersections of the gate lines and data lines.

The upper display plate 50 is disposed at a position opposite to the lower display plate 10 and can include a color filter 60 formed at a position corresponding to an area where pixel electrodes of the lower display plate 10 are formed, a black matrix 53 formed between the color filters 60, and a common electrode 63 formed below the color filter 60. The black matrix 53 may contact the color filter 60.

Specifically, referring to FIG. 5, the lower display plate 10 can include a transparent first insulating substrate 11, a thin film transistor Tr, a passivation layer 25, and a pixel electrode 30.

The upper display plate 50 can include a transparent second insulating substrate 51, the black matrix 53, the color filter 60, an overcoat layer 61, and the common electrode 63.

A liquid crystal cell 70 is formed between the lower display plate 10 and the upper display plate 50, wherein the liquid crystal cell 70 can include liquid crystals 73.

Liquid crystal alignment layers 35 and 65 can be formed on the pixel electrode 30 and the common electrode 63, respectively. Accordingly, the liquid crystal cell 70 can be located between the liquid crystal alignment layers 35 and 65.

The first insulating substrate 11 and the second insulating substrate 51 can be made of transparent glass substrates such as soda lime glass or borosilicate glass, or transparent plastics such as polyether sulfone and polycarbonate. However, the present disclosure is not limited thereto.

The first insulating substrate 11 can be a flexible substrate made of, for example, polyimide.

Gate wiring and data wiring can be formed on the first insulating substrate 11. The gate wiring includes gate lines and a gate electrode 13. The gate electrode 13 can be formed protruding from the gate line.

The gate wiring serves to transmit gate signals or gate voltages. The gate wiring can be made of aluminum-based metals such as aluminum (Al) and aluminum alloys, silver-based metals such as silver (Ag) and silver alloys, copper-based metals such as copper (Cu) and copper alloys, molybdenum-based metals such as molybdenum (Mo) and molybdenum alloys, chromium (Cr), titanium (Ti), tantalum (Ta), etc. However, the present disclosure is not limited thereto.

The data wiring can include data lines, a source electrode 21, and a drain electrode 23. The data wiring can serve to transmit data signals or data voltages. The data wiring can be made of chromium, molybdenum-based metals, refractory metals such as tantalum and titanium.

Here, the gate lines are formed in a horizontal direction, the data lines are formed in a vertical direction, and they can cross each other. The pixel electrode 30 can be formed within an area surrounded by the gate lines and the data lines that cross each other. The pixel electrode 30 can contact the drain electrode 23 through a contact hole provided in the passivation layer 25. One gate line can be allocated for each pixel.

A gate insulating layer 15 made of silicon nitride (SiNx) can be formed on the gate wire. A semiconductor layer 17 made of hydrogenated amorphous silicon or polycrystalline silicon can be formed on the gate insulating layer 15.

Ohmic contact layers 19 and 20 made of materials such as silicide or n+hydrogenated amorphous silicon doped with high concentrations of n-type impurities can be formed on top of each semiconductor layer 17. The ohmic contact layers 19 and 20 exist between the semiconductor layer 17 below them and the source electrode 21 and drain electrode 23 above them and serve to lower contact resistance. The ohmic contact layers 19 and 20 can be positioned on the semiconductor layer 17 in a mutually spaced state to expose a portion of the semiconductor layer 17 between the ohmic contact layers 19 and 20.

The source electrode 21 and the drain electrode 23 can be formed on the gate insulating layer 15 and the ohmic contact layers 19 and 20. Further, the source electrode 21 and the drain electrode 23 can be spaced apart with a portion of the passivation layer 25 located therebetween.

Specifically, the source electrode 21 can overlap with at least a portion of the semiconductor layer 17, and the drain electrode 23 can be positioned opposite the source electrode 21 relative to the gate electrode 13 and can overlap with at least a portion of the semiconductor layer 17. In other words, the source electrode 21 and the drain electrode 23 can be formed spaced apart from each other, and a portion of the semiconductor layer 17 can be exposed between the source electrode 21 and the drain electrode 23.

The passivation layer 25 can be formed on the data wiring and the exposed semiconductor layer 17. The passivation layer 25 can be made of inorganic materials such as silicon nitride or silicon oxide, organic materials having excellent planarization characteristics and photosensitivity, or low dielectric constant insulating materials such as a-Si:C:O and a-Si:O:F formed by plasma enhanced chemical vapor deposition (PECVD). However, the present disclosure is not limited thereto.

The passivation layer 25 can have a double layer structure of a lower inorganic layer and an upper organic layer to protect the exposed portion of semiconductor layer 17 while utilizing the excellent characteristics of the organic layer. Red, green, or blue color filter layers can also be used as the passivation layer 25.

A contact hole is formed in the passivation layer 25, and the pixel electrode 30 is electrically connected to the drain electrode 23 through the contact holes to receive a data voltage and a control voltage. In other words, the pixel electrode 30 may be located inside the contact hole.

The pixel electrode 30 to which the data voltage is applied can determine the arrangement of liquid crystals between the common electrode 63 and the pixel electrode 30 by generating an electric field in combination with the common electrode 63 of the upper display plate 50.

The black matrix 53 can be disposed below the second insulating substrate 51 so as to prevent light leakage and define pixel areas. Additionally, the black matrix 53 can contact the second insulating substrate 51. The black matrix 53 can be formed in portions corresponding to the gate line and the data lines and portions corresponding to the thin film transistor. The black matrix 53 can have various shapes to block light leakage in the vicinity of the pixel electrode 30 and thin film transistor.

The black matrix 53 can be made of metals (or metal oxides) such as chromium and chromium oxide, or organic black resist. The color filters 60 of red (R), green (G), and blue (B) can be sequentially arranged in the pixel areas between the black matrices 53. However, the present disclosure is not limited thereto.

An overcoat layer 61 for planarizing their step differences can be disposed below the color filter 60. A common electrode 63 made of transparent conductive materials such as ITO or IZO can be disposed below the overcoat layer 61.

The common electrode 63 is disposed to face the pixel electrode 30, and a liquid crystal cell 70 can be interposed between the common electrode 63 and the pixel electrode 30.

The liquid crystals 73 in the liquid crystal cell 70 can be pre-tilted with respect to surfaces of the lower display plate 10 and the upper display plate 50. For example, the liquid crystals 73 in the liquid crystal cell 70 can be pre-tilted by the liquid crystal alignment layers 35 and 65 formed on the pixel electrode 30 and the common electrode 63.

When no voltage is applied to the display panel 100 in the present disclosure, an image can be displayed in white on the front portion of the display panel 100 using light provided from the first light source (130 in FIG. 4) provided on a side surface of the light guide plate 120.

Light provided from the light guide plate 120 can become linearly polarized light while passing through a polarizing plate.

Light transmitted through the display panel 100 can be reflected by the reflection sheet 125 below the light guide plate 120 and be incident again on the display panel 100.

In this way, when no voltage is applied to the display panel 100, an image can be displayed in white on the front portion of the display panel 100 (Normally White Mode), and an image can be displayed in black on the rear portion of the display panel 100 (Normally Black Mode).

On the other hand, when voltage is applied to the display panel 100, an image can also be displayed in white on the rear portion of the display panel 100 using light provided from the first light source 130 of the light guide plate 120.

The display panel 100 can include pixel array areas into which pixel data of input images is written and a light transmission area UDC without pixels. The light transmission area UDC does not have a circuit layer provided with the thin film transistor Tr shown in FIG. 5. The light transmission area (UDC in FIG. 4) can be disposed within the pixel array area.

No opaque material layers that block or interfere with light exist in the light transmission area UDC of the display panel 100. Therefore, light emitted from the first light source (130 in FIG. 4) can travel toward the display panel 100 through the light transmission area UDC.

Light coming from outside can pass through the light transmission area UDC, travel below the display panel 100, and be primarily refracted through the concave lens 150 disposed below the light guide plate 120.

The primarily refracted light is secondarily refracted through the convex lens 180 disposed at the interface between the light guide module 160 and the optical sensor module 190, thereby enabling an increase in the field of view by utilizing the optical sensor module 190 even with the same hole size as conventional ones.

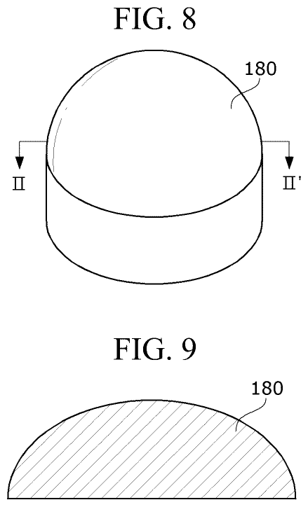

FIG. 6 is a perspective view showing an enlarged concave lens in the display device according to the first embodiment of the present disclosure. FIG. 7 is a cross-sectional view taken along line I-I′ of FIG. 6. FIG. 8 is a perspective view showing an enlarged convex lens in the display device according to the first embodiment of the present disclosure. FIG. 9 is a cross-sectional view taken along line II-II′ of FIG. 8.

Referring to FIGS. 6 and 7, the concave lens 150 can be positioned below the display panel 100 and can be mounted within the third opening 143 provided on a lower surface of the bottom cover 140 that surrounds structures including the display panel 100. The concave lens 150 can be disposed to directly face and overlap with a lower surface of the display panel 100. The concave lens 150 can be disposed at a position overlapping with the light transmission area UDC of the display panel 100.

Therefore, the concave lens 150 can serve to primarily refract external light coming through the light transmission area UDC of the display panel 100, directing it into the light guide module 160 located under the concave lens 150.

Referring to FIGS. 8 and 9, the convex lens 180 can be disposed on one side of the light guide module 160 disposed below the bottom cover 140 and can be positioned between the light guide module 160 and the optical sensor module 190 facing it. The convex lens 180 can be disposed on one side of the light guide module 160 that does not overlap with the light transmission area UDC and the first to third openings (115a, 125a, and 143 in FIG. 4).

Therefore, the convex lens 180 can serve to secondarily refract external light that has been primarily refracted through the concave lens 150 and passed through the light guide module 160 to be received by the optical sensor module 190.

In addition, the concave lens 150 may have a maximum length that extends in a direction perpendicular to a maximum length of the convex lens 180.

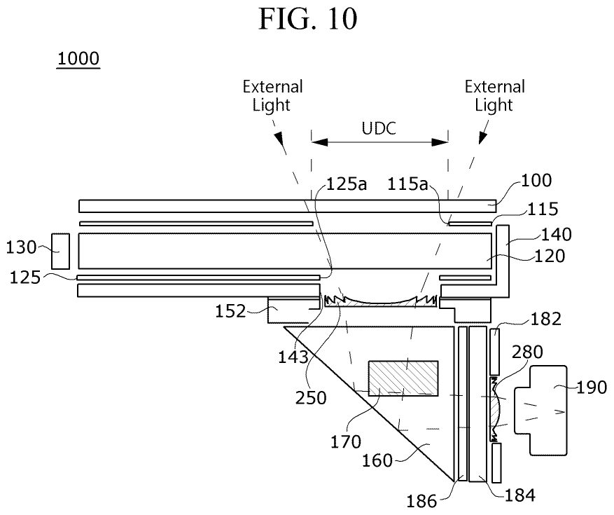

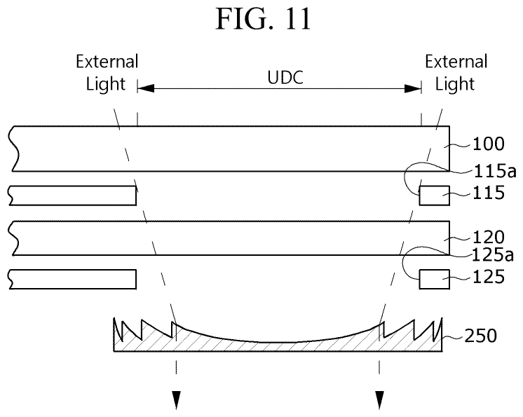

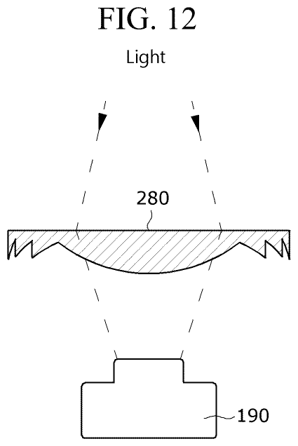

Next, FIG. 10 is a cross-sectional view of a display device according to a second embodiment of the present disclosure. FIG. 11 is an enlarged cross-sectional view showing a propagation path where external light is primarily refracted in the display device according to the second embodiment of the present disclosure. FIG. 12 is an enlarged cross-sectional view showing a propagation path of secondarily refracted light in the display device according to the second embodiment of the present disclosure.

The display device 1000 according to the second embodiment of the present disclosure differs only in the configuration of the concave lens and convex lens provided in the first embodiment of the present disclosure, and the remaining components are the same. Therefore, the description of the display device 1000 according to the second embodiment of the present disclosure will focus mainly on a Fresnel concave lens 250 and a Fresnel convex lens 280.

Specifically, referring to FIGS. 10 to 12, a Fresnel concave lens 250, instead of the concave lens 150 of the first embodiment in FIG. 4, can be disposed within the third opening 143 provided on the lower surface of the bottom cover 140. The Fresnel concave lens 250 can be disposed to overlap with the light transmission area UDC, the first and second openings 115a and 125a, and the upper surface of the light guide module 160. In this case, the Fresnel concave lens 250 is disposed within the third opening 143 provided on the lower surface of the bottom cover 140 to overlap with the light guide module 160, thereby serving to primarily refract the angle of the optical path of light coming from outside.

In addition, a Fresnel convex lens 280 can be disposed between one side surface of the light guide module 160 and the optical sensor module 190. The optical filters 184 and 186 that selectively transmit light of a specific wavelength band can be disposed between the light guide module 160 and the convex lens 280. The Fresnel convex lens 280 can be coupled and fixed by the lens support 182.

The Fresnel convex lens 280 can be coupled and fixed to the lens support 182 and can be positioned to overlap with the light guide module 160 and the optical sensor module 190.

Therefore, referring to FIG. 11, external light coming through the display panel 100 can be primarily refracted through the Fresnel concave lens 250.

Referring to FIG. 12, the primarily refracted light can pass through the light guide module 160 and then be secondarily refracted through the Fresnel convex lens 280 before being received by the optical sensor module 190.

For example, the Fresnel concave lens 250 and the Fresnel convex lens 280 can reduce the required material amount compared to conventional lenses by being divided into concentric ring-shaped sections. The Fresnel concave lens 250 and the Fresnel convex lens 280 can have an infinite number of cross-sectional structures. The overall thickness in each cross-sectional structure can be reduced compared to equivalent simple lenses. This is achieved by effectively dividing the continuous surface of a standard lens into a set of surfaces with the same curvature, with stepwise discontinuities between them.

In addition, the Fresnel concave lens 250 may have a maximum length that extends in a direction perpendicular to a maximum length of the Fresnel convex lens 280.

In some lenses, curved surfaces can be replaced with flat surfaces, and the angle can be different for each step. Such lenses can be regarded as a circular array of prisms with steep prisms at the edges and a flat or slightly convex center. However, the present disclosure is not limited thereto.

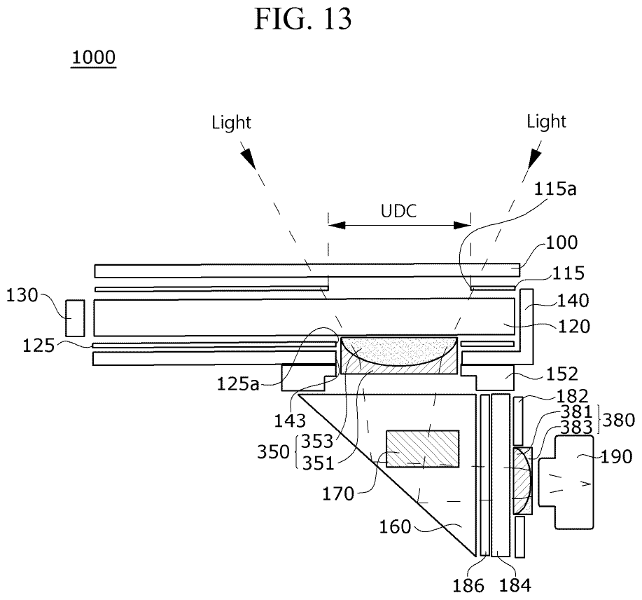

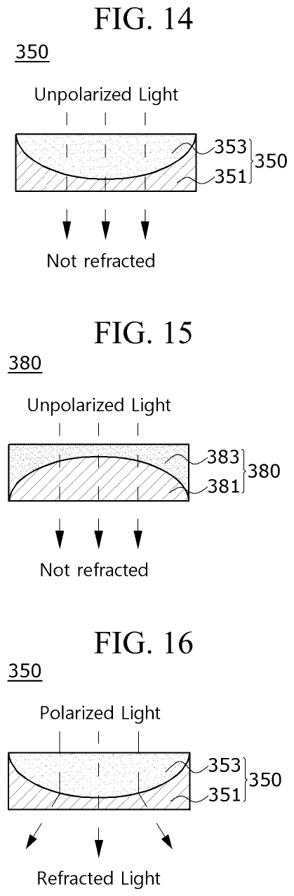

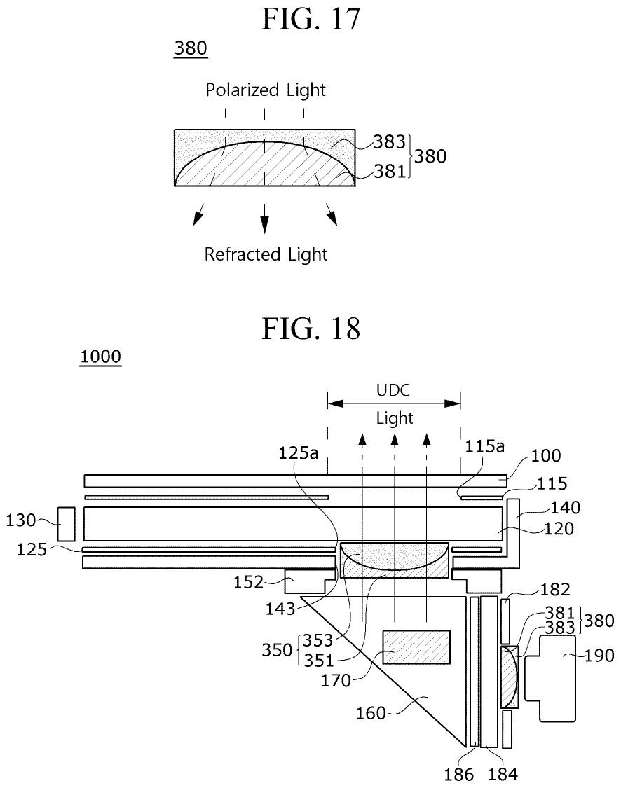

FIG. 13 is a cross-sectional view of a display device according to a third embodiment of the present disclosure. FIG. 14 is a cross-sectional view of a polarized concave lens in the display device according to the third embodiment of the present disclosure, showing a propagation path of unpolarized light passing through the polarized concave lens. FIG. 15 is a cross-sectional view of a polarized convex lens in the display device according to the third embodiment of the present disclosure, showing a propagation path of unpolarized light passing through the polarized convex lens. FIG. 16 is a cross-sectional view of a polarized concave lens in the display device according to the third embodiment of the present disclosure, showing a propagation path of polarized light passing through the polarized concave lens. FIG. 17 is a cross-sectional view of a polarized convex lens in the display device according to the third embodiment of the present disclosure, showing a propagation path of polarized light passing through the polarized convex lens.

The display device 1000 according to the third embodiment of the present disclosure differs only in the configuration of the concave lens and convex lens provided in the first embodiment of the present disclosure, and the remaining components are the same. Therefore, the description of the display device 1000 according to the third embodiment of the present disclosure will focus mainly on a polarized concave lens 350 and a polarized convex lens 380 as polarization-dependent lenses.

Specifically, referring to FIG. 13, the polarized concave lens 350, instead of the concave lens 150 of the first embodiment in FIG. 4, can be disposed within the third opening 143 provided on the lower surface of the bottom cover 140. The polarized concave lens 350 can be disposed to overlap with the light transmission area UDC, the first and second openings 115a and 125a, and an upper surface of the light guide module 160.

The polarized concave lens 350 can include a concave lens layer 351 and a first transparent layer 353. The first transparent layer 353 can be located closer to the display panel 100 than the concave lens layer 351. The polarized concave lens 350 is a polarization-dependent lens that allows unpolarized light to pass through without refraction as shown in FIG. 14, and refracts and allows polarized light to pass through as shown in FIG. 16.

Referring to FIG. 14, the concave lens layer 351 and the first transparent layer 353 can have the same refractive index values for unpolarized light. On the other hand, for polarized light as shown in FIG. 16, the concave lens layer 351 can have a higher refractive index than the first transparent layer 353.

The polarized concave lens 350 can be disposed within the third opening 143 provided on the lower surface of the bottom cover 140 to overlap with the light guide module 160, thereby serving to primarily refract the angle of the optical paths of polarized coming from outside.

Referring to back FIG. 13, the polarized convex lens 380 can be disposed between one side surface of the light guide module 160 and the optical sensor module 190. The optical filters 184 and 186 that selectively transmit light of a specific wavelength band can be disposed between the light guide module 160 and the polarized convex lens 380. The polarized convex lens 380 can be coupled and fixed by the lens support 182.

The polarized convex lens 380 can include a convex lens layer 381 and a second transparent layer 383. The second transparent layer 383 can be located closer to the sensor module 190 than the convex lens layer 381. The polarized convex lens 380 is a polarization-dependent lens that allows unpolarized light to pass through without refraction as shown in FIG. 15, and refracts and allows polarized light to pass through as shown in FIG. 17.

The convex lens layer 381 and the second transparent layer 383 can have the same refractive index values for unpolarized light. On the other hand, for polarized light, the convex lens layer 381 can have a higher refractive index than the second transparent layer 383.

The polarized convex lens 380 is coupled and fixed to the lens support 182 and can be positioned to overlap with the light guide module 160 and the optical sensor module 190.

Therefore, referring to FIGS. 13 and 16, polarized external light coming through the display panel 100 can be primarily refracted through the polarized concave lens 350.

Referring to FIGS. 13 and 17, the primarily refracted light can pass through the light guide module 160 and then be secondarily refracted through the polarized convex lens 380 before being received by the optical sensor module 190.

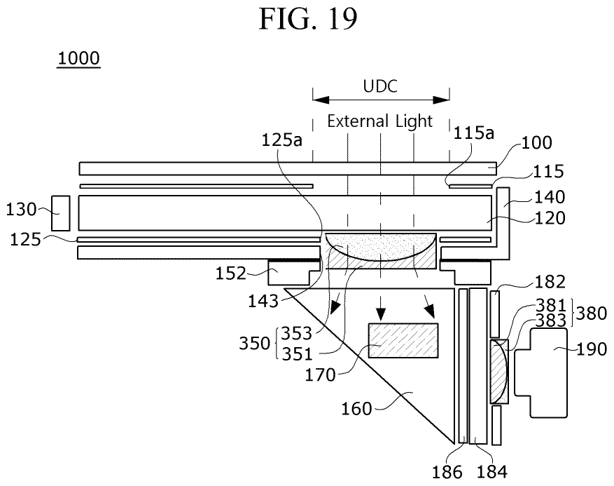

FIG. 18 is a cross-sectional view showing a propagation path of light emitted from a second light source in the display device according to the third embodiment of the present disclosure. FIG. 19 is a cross-sectional view showing a propagation path where polarized light is received by an optical sensor module through a polarized concave lens in the display device according to the third embodiment of the present disclosure.

Referring to FIG. 18, light emitted from the second light source 170 can be received toward the display panel 100 through the polarized concave lens 350 in an unpolarized state. In this case, since the polarized concave lens 350 does not refract unpolarized light, the light emitted from the second light source 170 can pass through the polarized concave lens 350 without refraction and enter the light transmission area UDC of the display panel 100.

Referring to FIG. 19, polarized external light incident through the display panel 100 can be primarily refracted through the polarized concave lens 350 and enter the light guide module 160. In this case, the concave lens layer 351 and the first transparent layer 353 constituting the polarized concave lens 350 can primarily refract the polarized light incident through the display panel 100 due to the difference in refractive index. In other words, since the refractive index of the concave lens layer 351 is greater than the refractive index of the first transparent layer 353, the polarized light coming from outside can be refracted.

The primarily refracted light that is propagated through the light guide module 160 can be secondarily refracted while passing through the polarized convex lens 380 again and be received by the optical sensor module 190.

In this process, the convex lens layer 381 and the second transparent layer 383 constituting the polarized convex lens 380 can cause secondary refraction of the primarily refracted polarized light due to the difference in refractive index, directing it toward the optical sensor module 190. In other words, since the refractive index of the convex lens layer 381 is greater than the refractive index of the second transparent layer 383, the primarily refracted polarized light can be secondarily refracted.

In this way, according to the present disclosure, by applying polarization-dependent polarized concave lens 350 and polarized convex lens 380 whose refraction characteristics vary depending on the presence or absence of polarization, only light received by the optical sensor module 190 can be refracted, and light emitted from the second light source 170 toward the outside is not refracted, thereby minimizing display image quality degradation.

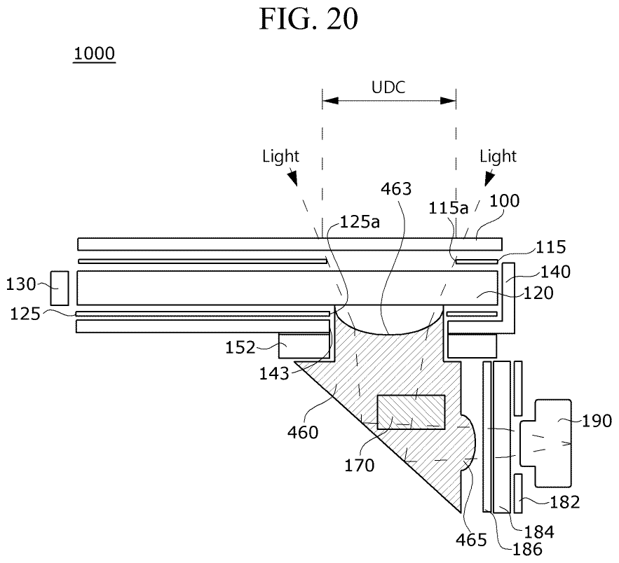

FIG. 20 is a cross-sectional view of a display device according to a fourth embodiment of the present disclosure.

Referring to FIG. 20, the display device 1000 according to the fourth embodiment of the present disclosure differs only in the configuration of the light guide module, the concave lens, and the convex lens provided in the first embodiment of the present disclosure, and the remaining components are the same. Therefore, the description of the display device 1000 according to the fourth embodiment of the present disclosure will focus mainly on a concave lens portion 463 and a convex lens portion 465 integrally configured in a light guide module 460.

Specifically, a prism-shaped light guide module 460 can be disposed on a lower surface of the bottom cover 140. The concave lens portion 463 can be formed on an upper surface of the light guide module 460 to overlap with the third opening 143 provided on the lower surface of the bottom cover 140. In this case, the concave lens portion 463 can be integrally configured with the light guide module 460. The concave lens portion 463 can be positioned to overlap with the light transmission area UDC and the first to third openings 115a, 125a, and 143.

Here, the concave lens portion 463 provided on the upper surface of the light guide module 460 is positioned to overlap with the third opening 143 provided on the lower surface of the bottom cover 140, thereby serving to primarily refract the angle of optical paths of light coming from outside through the light transmission area UDC and the first to third openings 115a, 125a, and 143.

The convex lens portion 465 can be formed on one side of the light guide module 160 to face and overlap with the optical sensor module 190. In this case, the convex lens portion 465 can be integrally configured with the light guide module 160.

The optical filters 184 and 186 that selectively transmit light of a specific wavelength band can be disposed between the convex lens portion 465 and the optical sensor module 190. Additionally, the optical filters 184 and 186 can be spaced apart from the convex lens portion 465.

Therefore, referring to FIG. 20, external light coming through the display panel 100 can be primarily refracted through the concave lens portion 463 on the upper surface of the light guide module 460.

The primarily refracted light can then pass through the light guide module 460 and can be secondarily refracted through the convex lens portion 465 on one side of the light guide module 460 before being received by the optical sensor module 190.

In this way, according to the present disclosure, by arranging the concave and convex lenses on the upper side and one side of the light guide module facing the optical sensor module to perform primary and secondary refraction on external light, the field of view (FOV) can be increased by utilizing an optical sensor module even with the same aperture size of the light transmission area as conventional ones.

According to the present disclosure, by applying polarization-dependent polarized concave and convex lenses whose refraction characteristics vary depending on the presence or absence of polarization, only light received by the optical sensor module is refracted, and light emitted from the second light source toward the outside is not refracted, thereby minimizing display image quality degradation.

A display device according to another aspect of the present disclosure can include a display panel including a first area including a light transmission area and a second area that surrounds the first area, a first lens located below the light transmission area, the first lens being configured to receive light transmitted through the light transmission area of the display panel, a light guide module located below the first lens and including a prism configured to reflect light that passes through the first lens, a second lens located to a side of the light guide module and configured to receive light that passes through the first lens and is reflected by the light guide module, and an optical sensor module located adjacent to the second lens and configured to receive light that passes through the second lens.

In addition, the first lens can be a concave lens, the second lens can be a convex lens, and the prism can include a first side located closest to the first lens, a second side located closest to the second lens, and a third side that is a hypotenuse.

Additionally, according to another aspect of the present disclosure, the display device can also include a first light source located under an upper surface of the display panel under the second area, the first light source being configured to direct light towards the upper surface of the display panel, and a second light source located on a side of the prism of the light guide module such that the second light source does not overlap with the light transmission area and the first lens, the second light source being configured to direct light towards the light guide module such that the light guide module redirects the light to the light transmission area.

The embodiments of the present disclosure have been described in more detail with reference to the accompanying drawings, but the present disclosure is not necessarily limited to these embodiments, and various modifications can be made within the scope without departing from the technical idea of the present disclosure.

Therefore, the embodiments disclosed in the present application are not intended to limit the technical idea of the present disclosure but to illustrate it, and the scope of the technical idea of the present disclosure is not limited by these embodiments.

Therefore, the embodiments described above should be understood as illustrative in all respects and not restrictive.

The protection scope of the present disclosure should be interpreted by the claims, and all technical ideas within the equivalent scope should be interpreted as being included in the scope of rights of the present disclosure.

What is claimed is:

1. A display device comprising:
a display panel including a light transmission area;
a concave lens located below the display panel and overlapping with the light transmission area;
a light guide module located below the concave lens;
a convex lens located at a side of the light guide module; and
an optical sensor module located adjacent to the convex lens.

2. The display device of claim 1, further comprising:
an optical sheet disposed between the display panel and the concave lens;
a light guide plate disposed between the display panel and the concave lens;
a reflection sheet disposed between the display panel and the concave lens;
a first light source disposed on a first side of the light guide plate;
a bottom cover surrounding the optical sheet, the light guide plate, the reflection sheet, and the first light source; and
a second light source disposed on a second side of the light guide plate.

3. The display device of claim 2, wherein a first opening, a second opening and a third opening are located in the optical sheet, the reflection sheet, and the bottom cover, respectively, and
the first opening, the second opening, and the third opening overlap with the concave lens.

4. The display device of claim 2, wherein the first light source and the second light source include at least one of a light emitting diode (LED), a cold cathode fluorescent lamp (CCFL), and an external electrode fluorescent lamp (EEFL).

5. The display device of claim 1, wherein the concave lens includes a concave-shaped Fresnel lens or a polarized concave lens, and
the convex lens includes a convex-shaped Fresnel lens or a polarized convex lens.

6. The display device of claim 5, wherein the polarized concave lens includes a concave lens layer and a transparent material layer, and
the polarized convex lens includes a convex lens layer and a transparent material layer.

7. The display device of claim 6, wherein, when polarized light is received by the optical sensor module through the polarized concave lens, the polarized light is firstly refracted through the concave lens layer and the transparent material layer of the polarized concave lens, and secondarily refracted through the convex lens layer and the transparent material layer of the polarized convex lens.

8. The display device of claim 7, wherein the concave lens layer has a higher refractive index than a refractive index of the transparent material layer, and
the convex lens layer has a higher refractive index than a refractive index of the transparent material layer.

9. The display device of claim 6, wherein light emitted from a second light source toward an outside of the display device is not refracted by the polarized concave lens.

10. The display device of claim 1, wherein the optical sensor module includes one or more optical sensors including an imaging module, and the imaging module including one or more of a camera and an image sensor, an infrared sensor module, and an illuminance sensor module.

11. The display device of claim 1, wherein external light incident through the display panel is firstly refracted through the concave lens, and passes through the light guide module, and is secondarily refracted through the convex lens such that the refracted light is received by the optical sensor module.

12. A display device comprising:
a display panel including a light transmission area;
a light guide module located below the display panel, the light guide module including:
a concave lens portion overlapping with the light transmission area, and
a convex lens portion; and
an optical sensor module located at a side of the light guide module, the optical sensor module being located adjacent to the convex lens portion.

13. The display device of claim 12, further comprising:
an optical sheet disposed between the display panel and the light guide module;
a light guide plate disposed between the display panel and the light guide module;
a reflection sheet disposed between the display panel and the light guide module;
a first light source disposed on a first side of the light guide plate;
a bottom cover surrounding the optical sheet, the light guide plate, the reflection sheet, and the first light source; and
a second light source disposed on a second side of the light guide plate.

14. The display device of claim 13, wherein a first opening, a second opening and a third opening are located in the optical sheet, the reflection sheet, and the bottom cover, respectively, and
the first opening, the second opening, and the third opening overlap with the concave lens portion.

15. The display device of claim 13, wherein the first light source and the second light source include at least one of a light emitting diode (LED), a cold cathode fluorescent lamp (CCFL), and an external electrode fluorescent lamp (EEFL).

16. The display device of claim 12, wherein the concave lens portion includes a concave-shaped Fresnel lens or a polarized concave lens, and
the convex lens portion includes a convex-shaped Fresnel lens or a polarized convex lens.

17. The display device of claim 12, wherein the optical sensor module includes one or more optical sensors including an imaging module, and the imaging module including one or more of a camera and an image sensor, an infrared sensor module, and an illuminance sensor module.

18. The display device of claim 12, wherein the concave lens portion and the convex lens portion are integrally configured with the light guide module.

19. A display device comprising:
a display panel including a first area including a light transmission area and a second area that surrounds the first area;
a first lens located below the light transmission area, the first lens being configured to receive light transmitted through the light transmission area of the display panel;
a light guide module located below the first lens and including a prism configured to reflect light that passes through the first lens;
a second lens located to a side of the light guide module and configured to receive light that passes through the first lens and is reflected by the light guide module; and
an optical sensor module located adjacent to the second lens and configured to receive light that passes through the second lens.

20. The display device of claim 19, further comprising:
a first light source located under an upper surface of the display panel under the second area, the first light source being configured to direct light towards the upper surface of the display panel; and
a second light source located on a side of the prism of the light guide module such that the second light source does not overlap with the light transmission area and the first lens, the second light source being configured to direct light towards the light guide module such that the light guide module redirects the light to the light transmission area.
